(19) United States
(12) Patent Application Publication
(10) Pub. No.: US 2004/0152408 A1
(43) Pub. Date: Aug. 5, 2004

(54) Method and assembly for controlling the air conditioning of high-speed vehicles

(76) Inventor: Michael Eckhardt, Berlin (DE)

Correspondence Address: HOWREY SIMON ARNOLD & WHITE, CITYPOINT, ONE ROPEMAKER STREET, LONDON, EC2Y 9HS, GB

(21) Appl. No.: 10/472,212

(22) PCT Filed: Mar. 21, 2002
(86) PCT No.: PCT/EP02/03204

(30) Foreign Application Priority Data
Mar. 21, 2001 (DE) 101 14 524.1

(51) Int. Cl. B60H 1/00

(52) U.S. Cl. 454/99

(57) ABSTRACT

The invention relates to a method for controlling the air conditioning of high-speed vehicles, in particular rail vehicles. According to said method, to observe at least one predetermined limit of at least one air quality value in the vehicle interior (8), fresh air is taken in from the environment of the vehicle and processed additional air is supplied to the vehicle interior (8) via at least one air conditioning device (7), said additional air consisting of a fresh air portion and/or an ambient air portion of the recirculated ambient air from the vehicle interior (8). The air is controlled by means (6) for determining the air quality value, whereby the fresh air portion is kept to a minimum, dependent on the number of passengers carried in the vehicle interior (8), in such a way that a predetermined tolerance range for the air quality value is essentially observed, at least during normal operation without pressure fluctuations. The invention also relates to an assembly for carrying out said method.

The invention relates to a method for controlling the air conditioning of high-speed vehicles, in particular, rail vehicles, in which for observing at least one predetermined limit of at least one air quality value in the vehicle interior, fresh air is taken in from the environment of the vehicle and via at least one air treatment device, processed additional air is supplied to the vehicle interior, which contains a fresh air portion and/or a recirculating air portion of the recirculating air from the vehicle interior. The invention relates further to a corresponding assembly for controlling the air conditioning of high-speed vehicles.

The invention is particularly suited for use in rail vehicles for passenger traffic with a highest speed over 160 km/h. However, the invention is not limited only to this use.

With vehicles, in particular, rail vehicles and magnetic suspension vehicles, unwanted reactions with the environment in the form of so-called pressure events take place as a result of their high speed, the direct affects of which on the passengers are suppressed at exact dosing of necessary amounts of fresh air.

The air conditioning systems used to this point have the disadvantage that the passenger areas are supplied independently from the occupancy with the maximum, constant amount of fresh air, that is, with each occupancy beneath 100%, the amount of fresh air is unnecessarily large and the energy use for conditioning of the fresh air appears disproportionately high.

The disclosure document DE 44 32 277 A1 describes a pressure protection system with quickly changing air cross sections and the possibility of realizing permanently a smaller fresh air flow with observance of the threshold value of the interior pressure/interior pressure change in the event of pressure protection via separate, speed-adjustable bypass blowers with steep supply characteristic lines on the fresh air and exhaust air sides.

This pressure protection system leads to a stealthy infiltration of the supplied amount of fresh air required in the standards DIN EN 13129 and UIC 553, since occasionally as a result of pressure events, the fresh air supply is smaller or cut off. In particular, in spite of the noted bypass air supply, the danger exists of exceeding the acceptable CO₂ concentration in the threshold power region of the air conditioning assembly.

The basic disadvantages noted in DE 44 32 277 A1 of other pressure protection systems exclusively with pressure protection ventilators, such as a higher required expense for noise insulation and a higher energy expense, are not resolved. In addition, this system requires a high control and regulation expense.

In the patent document DE 196 49 664 C2, a method for pressure-protected ventilation of high-speed trains is described. There, the opening cross sections of the throttle flaps and speeds of the blowers on the fresh air and exhaust air sides, corresponding to their throttle and supply characteristics, are adjusted such that the internal pressure and the fresh air amount only insubstantially changes with pressure events and the fresh air supply is interrupted only rarely.

A disadvantage with this system is the system-related, high construction expense for making possible sufficiently fast speed adjustment, such as frequency-adjustable alternating current drives or electronically commutated direct current drives, as well as the expense for quickly changing the opening cross sections of the throttle flaps.

The European patent application EP 0 751 054 A1 discloses a pressure protection system, comprising a combination of an air conditioning assembly with specialized pressure protection blowers with steep supply characteristic lines, preferably, cell or rolling piston constructions, on the fresh air and the exhaust air side, which permits a permanent fresh air supply with observance of the threshold value of the internal pressure/internal pressure change.

The high construction expense for noise insulation and the high energy expense for operating this system are disadvantageous.

Finally, the patent document DE 197 55 097 C1 discloses a valve closure-scavenging air system, in which, in addition to the pressure protection valves and blowers on the fresh air and exhaust air sides arranged in succession, a further pressure protection valve is arranged parallel on the fresh air side and a further blower is arranged on the exhaust air side, whereby in co-operation with a fresh air-recirculation air flap, it is possible to perform occasionally a scavenging operation with a higher amount of fresh air than normal for lowering the CO₂ concentration occurred as a result of closed pressure protection valves with a pressure event. The control of the scavenging operation takes place via an estimation of the CO₂ level in the passenger area from the experience values, as well as via the expected or known course, that is, the succession and above all the duration, of the pressure events in operation, from which the required air scavenging amount is calculated.

One disadvantage with this system is that depending on the assumptions used for the calculation, in operation, in particular, in a scavenging operation, a comparatively high energy expense for the conditioning of the supply air combined from the fresh air and recirculating air is associated. A further disadvantage of this system relates to the plurality of the required pressure protective valves, flaps, and blowers, which is negative for the dependability of the entire system.

In conclusion, the substantially separate examination of the air conditioning and pressure protection systems up to this point have the result that generally, too much or too little ventilation is provided, and, only as an exception, the correct requirements are met. The combination of the useable air conditioning and pressure protections systems until now corresponds only incompletely to the specifications desired by customers today, in terms of energy consumption or quantities of fresh air.

An object of the present invention is to make available a method and assembly of the above-described type, which does not have the described disadvantages of the state of the art or at least, has these only to a smaller extent, and in particular, make possible an energy-optimized supply of fresh air.

This object is resolved, starting from a method according to the preamble of claim 1, by the features provided in the characteristic part of claim 1. It is further resolved, starting from an assembly according to the preamble of claim 11, by the features provided in the characteristic part of claim 11.

The present invention is based on the technical teaching of obtaining a particularly energy efficient method for air conditioning high speed vehicles, when the control takes place via means for determining the air quality value, whereby the fresh air part, depending on the occupancy in the vehicle interior, is kept minimized in such a manner that a predetermined tolerance range of the air quality value is essentially maintained at least in a normal operation without pressure events. The means of determining the air quality value permit in an advantageous manner to draw conclusions about the air quality from information on the occupancy in the vehicle interior obtained in this manner so that depending on this assessment, only the minimal necessary amount of fresh air has to be supplied to keep the predetermined limits of the air quality value. This minimizing of the fresh air supply according to the present invention means that at least in normal operation without pressure events, only a minimal amount of fresh air must be conditioned at light expense, so that generally, the expense for the air conditioning of the additional air is substantially reduced, namely, to the minimal amounts required for keeping the predetermined limits.

The conclusions on the occupancy in the vehicle interior can be drawn in normal running operation, for example, by detecting, continuously or discontinuously with correspondingly small intervals, the air quality value for using it directly for controlling the ratio of fresh air/recirculating air. Alternatively, first, for a predetermined time frame, ventilation may be performed with a predetermined ratio of fresh air to recirculating air and the change of the air quality value provided thereby may be determined. This change can be compared then with one or more reference values for this ratio of fresh air to recirculating air, in order to draw conclusions on the actual occupancy. Thus, the occupancy can be determined, for example, by comparing the change with the contents of a table, which contains, for the predetermined ratio of fresh air to recirculating air, change values associated to different degrees of occupancy. It is to be understood that also a pressure protection situation can be simulated, in which the ratio of fresh air to recirculating air equals zero, that is, only recirculating air is supplied as supply air to the vehicle interior.

In contrast to the state of the art, in which care is taken that an upper limitation of the air quality value is not exceeded, according to the present invention, ventilation is provided that is minimized need conformingly and energy-optimized.

As far as the occupancy permits, the fresh air supply preferably is held this minimized also in other operational modes than the normal operation. If necessary, the predetermined tolerance range, however, can also be dependent on determined acting loads for example. It may depend on the temperature, in particular, the outer temperature, or similar outer loads. Likewise, it may of course be occupancy-dependant, that is, depending on the occupancy determined, for example, from the measured values.

Preferably, depending on the occupancy in the vehicle interior, the fresh air portion is kept minimized in such a manner that at least in normal operation, a predetermined, narrow tolerance range of the air quality value essentially is maintained. The narrower the tolerance range, of course, the less is the required energy expenditure for conditioning the fresh air. Preferably, the tolerance range of the air quality value amounts to 20% at the most of a predetermined air quality value. Furthermore, preferably, the tolerance range lies at 10% at the most of a predetermined air quality value.

The term tolerance range hereby designates the difference range between the maximum and minim allowed deviation from the predetermined air quality value. Therefore, the tolerance range must not be symmetrical to the predetermined air quality value, rather it can be that different deviations are provided above and below. Thus, with an asymmetrically arranged tolerance region of 10% above, a deviation of 2% from the predetermined air quality value can be provided, while below, a deviation of 8% is provided. With a symmetrically arranged tolerance range of 10%, then, above and below, a deviation of 5% from the predetermined air quality value is provided,

In addition, it is to be noted that the predetermined air quality value can vary over time, that is, over the travel route. Thus, for example, before a long pressure protection operation in along tunnel, etc., it can be necessary to improve the air quality correspondingly intensely, in order to ensure that it does not worsen over the pressure protection operation over a predetermined limit. For example, the CO₂-content must be correspondingly intensely lowered, in order to ensure than it does not increase in a long tunnel with pressure protection operation over the allowed value. This lowering can take place already in a scavenging operation after a previous pressure event, before being again switched into normal operation. Since in this second normal operation, however, under certain circumstances, a substantially lower CO₂ value than in the previous first normal operation may have to be maintained, the predetermined air quality value, around which the tolerance range is to be maintained, is correspondingly lowered.

Therefore, particularly narrow tolerance regions can be maintained, and particularly high energy savings can be achieved, when, according to preferred embodiments of the method of the present invention, the predetermined air quality value is varied. This variation preferably takes place in dependence on the position of the vehicle on a known route course, that is, depending on the starting point and the duration of the pressure events. The control preferably takes place over signals of the external train control.

The means for determining the air quality value can detect the air quality value basically in different ways. Preferably, they are arranged in the vehicle interior or in a chamber, in which approximately the same air quality prevails, and determine a measured parameter representative for the air quality, such as, for example, the CO₂ content or other measured parameters representative for the air quality.

By the use of corresponding sensors, a reference value of the prevailing concentration in the vehicle interior of noxious or offensive smelling substances is permanently monitored, which allows for dispensing of the necessary fresh air amount according to the occupancy and according to the frequency of the pressure events. The use of other sensors is contemplated, which do not monitor the CO₂ concentration, or monitor not only this CO₂ concentration, but the concentrations of actual disturbing gases, etc.

With preferred variations of the method of the present invention, it is provided that in a pressure protection situation, as a result of an outer pressure event, a pressure protection operation takes place, in which the fresh air part is essentially equal to zero. In such a pressure protection situation, so-called pressure protection valves are activated, which partition the vehicle on the fresh air side as well as the exhaust air side from the environment. After the end of the pressure protection situation and before switching over to normal operation, then, a scavenging operation takes place, in which the fresh air portion is kept the same or greater than the fresh air portion in normal operation. Here as well, the scavenging operation again takes place advantageously need conformingly, that is, it is scavenged with a correspondingly increased fresh air portion only if, as a result of higher occupancy, only by this means a sufficiently quick improvement of the air quality is possible.

Preferably, for control of the fresh air portion and of the recirculating air portion in the scavenging operation, in a first step for assessment of the occupancy in the vehicle interior, a change value representative for the change of the air quality value during the pressure protection operation is determined. At the end of the pressure protection operation, the air quality value is then compared in a first comparison with a predetermined first threshold value. Finally, in a second step, depending on the change value and the first comparison, the fresh air portion during the scavenging operation is determined.

With advantageous variations of the method of the present invention, in the second step, in dependence on the change value and the fist comparison, the initiation time point of the scavenging operation is determined. The more intense the change in the pressure protection operation, the earlier the scavenging operation initiates, preferably. Alternatively or additionally, the duration of the scavenging operation may be determined. The more intense the change in the pressure protection operation is, the longer the scavenging operation is, preferably. Likewise, alternatively or in addition, the intensity of the scavenging operation can be determined. The more intense the change in the pressure protection operation, the more intense is the scavenging operation, that is, it is scavenged with a greater air flow, for example. With all of these variations, a simple scavenging and above all a need conforming scavenging is possible in an advantageous manner.

With preferred embodiments of the present invention, as the air quality value, a value representative for the CO₂ concentration in the vehicle interior is used. Thus, for example, the CO₂ concentration can be measured directly via a corresponding sensor. In addition or alternatively, also a value representative for another chemical or biological measurement category can be used. Here, for example, likewise the concentrations of determined chemical substances in the air can be measured, which have an effect on the air quality, such as the number of germs of determined, damaging germs, etc.

It is to be understood that, of course, additionally, also further air quality values may be monitored, and may be taken into consideration with the adjustment of the fresh air portion. Thus, for example, the air moisture may be determined. Basically, all categories can be determined individually or in combination, from which, for example, with so-called comfort formulas, conclusions on the quality of the air or its action on the passengers can be drawn.

With advantageous variation of the method of The present invention, it is provided that with a normal operation without pressure events and, additionally or alternatively, with a first scavenging operation after a short pressure event via an exhaust air-blower device, exhaust air is conducted into the surrounding environment of the vehicle, whereby the exhaust air-blower device supplies exhaust air from the vehicle interior with a first air flow. In contrast, with a second scavenging operation, the exhaust air-blower device supplies exhaust air with a second air flow being increased relative to the first air flow, after a sufficiently longer pressure event, in order to achieve an accelerated adaptation of the air quality value in the vehicle interior in relation to the first scavenging operation in an advantageous manner. This manner of operation preferably is maintained until the air quality value reaches a predetermined value or a new pressure event occurs.

Further energy savings take place with advantageous variations, in which the exhaust air-blower device is switched off with the occurrence of a pressure event, so that it must not supply against a closed pressure protection valve.

The switching between the individual operating modes may take place in dependence on parameters determined by corresponding sensors, such as, for example, the pressure in the environment of the train. With preferred variations of the method of the present invention, however, it can also be provided that the switching between types of operation, in particular, the switching to the pressure protection operation and, additionally or alternatively, to the scavenging operation, in which the fresh air portion is kept the same or greater relative to the fresh air portion in a normal operation without pressure events, is triggered by a signal of the external train control. Thus, for example, it may be provided that the pressure protection situation or the scavenging operation is not triggered by an actually determined pressure increase to an over pressure or a pressure drop to a normal pressure, but rather by reaching a determined route section, in which such a change is to be expected. This can be the case when reaching the beginning or the end of a tunnel or the like.

The present invention further relates to an assembly for controlling air conditioning of high speed vehicles, in particular, rail vehicles, with an air supply device for conducting supply air in the vehicle interior, which includes a fresh air supply device for supplying fresh air from the surrounding environment of the vehicle into the vehicle interior, a recirculating air return device for returning recirculating air from the vehicle interior into the vehicle interior, as well as at least one air conditioning device for conditioning the supply air, and a control device connected therewith for controlling the ratios between the fresh air portion and the recirculating air portion of the supply air, which is formed for keeping at least one predetermined limit of the air quality value in the vehicle interior. According to the invention, the control device includes means for determining at least one air quality value in the vehicle interior. In addition, the control device is formed for minimizing the fresh air portion, such that at least in a normal operation without pressure events, a predetermined tolerance range of the air quality value is essentially maintained depending on the occupancy in the vehicle interior.

With this assembly of the present invention, the advantages described above in connection with the method of the present invention can be achieved in the same manner, so that here, reference is made to the above considerations.

Preferably, it is also provided here that the control device is formed for minimizing the fresh air portion in dependence on the occupancy in the vehicle interior and essentially with maintenance of a predetermined narrow tolerance range of the air quality value. Again, the tolerance range of the air quality value amounts to essentially 20% at the most, preferably 10% at the most, of a predetermined air quality value.

For assessing the occupancy in the vehicle interior, the control device preferably is formed for determining a change value representative for the change of the air quality value during the pressure protection operation. Thus, it is formed for comparison of the air quality value in a first comparison at the end of a pressure protection operation with a predetermined, first threshold value, as well as for subsequent determination of the fresh air portion, which is set during a scavenging operation after the pressure protection operation, wherein this determination occurs depending on the change value and the first comparison.

Preferably, the control device is formed for determining the initiation time point of the scavenging operation and/or the duration of the scavenging operation and/or the intensity of the scavenging operation in dependence on the change value and the first comparison.

With advantageous variations of the assembly of the present invention, the means for determining the air quality value include a corresponding sensor for a measuring parameter, which is representative for the CO₂ concentration in the vehicle interior. In the simplest case, this may be a corresponding CO₂ sensor. As set forth above with reference to the method of the present invention, also other measuring parameters can be determined by corresponding sensors.

In order to achieve a quick and need conforming adaptation of the air quality to a predetermined value, preferably it is provided that an exhaust air-blower device for conducting exhaust air in the environment of the vehicle and controlled by the control device is provided, which with normal operation without pressure events and/or with a first scavenging operation after a short pressure event supplies a first air flow from the vehicle interior and with a second scavenging operation after a sufficiently long pressure event, supplies a second air flow increased relative to the first air flow for an accelerated adaptation of the air quality value in the vehicle interior to the predetermined air quality value, relative to the first scavenging operation. This manner of operation is preferably maintained until the air quality value reaches the predetermined value or a new pressure event occurs.

In order to achieve this increased second air flow, different structures are possible. Thus, the exhaust air-blower device may include multiple blowers, of which one or more are hooked up for increasing the air flow. Likewise, the flow cross section can be correspondingly enlarged. With advantageous, simple construction variations, it is provided that the exhaust air-blower device includes at least one exhaust air blower, which is formed to be at least two-stage speed-adjustable, in order to enable achieving the increase of the air flow by a higher rotational speed.

With a particularly energy-saving variation, it is provided that the control device is formed for switching off the exhaust air-blower with the occurrence of a pressure event.

With preferred embodiments of the assembly of the present invention, the control device is formed for switching between types of operation, in particular, for switching to a pressure protection operation and, additionally or alternatively, to a scavenging operation, in which the fresh air portion is kept the same or greater relative to the fresh air portion in normal operation without pressure events, said switching being triggered by a signal of the external train control.

The ratio between additional air and recirculating air may be adjusted in any manner. Thus, for example, separate controllable blower devices for the fresh air and the recirculating air may be provided. With preferred variations of the assembly of the present invention, being simple to realize and also simple to regulate in view of the supplied air amounts, it may be provided, however, that the air supply device includes means for adjusting the ratio between the fresh air portion and the recirculating air portion controlled by the control device. Preferably, an adjustable, or even more preferred, a continuously adjustable recirculating air screen is provided in the area of the recirculating air return device.

It is particularly simple to realize this when the additional air device includes a first air supply blower, which supplies the fresh air and the recirculating air, so that with a constant air flow supplied through the blower, only the ratio between the fresh and recirculating air is adjusted.

The pressure conditions, in particular, the occurrence of pressure events in the vehicle interior, need not necessarily be determined directly by corresponding sensors. It can suffice that this is determined by signals of the external train control, as described above. Preferably, however, for detecting and taking into consideration pressure events, the control device includes at least one pressure sensor, for determining the pressure conditions in the vehicle interior, since, thus, a control in dependence on the actual conditions can take place in an advantageous manner. This sensor is preferably arranged in the vehicle interior. Of course, also multiple pressure sensors may be provided. Thus, for example, multiple pressure sensors may be distributed over the length of a train made from multiple wagons with independent pressure protection devices, by means of which the pressure protection devices may be activated individually and/or in groups, in order to ensure that—for example, within a tunnel—the pressure protection operation is maintained only as long as is absolutely necessary. In this connection, it should be noted that the term “vehicle interior” in the sense of the present invention should designate the region, which is supplied by the corresponding assembly. This may include the entire train or also only individual wagons and/or groups of wagons.

With advantageous variations of the method of the present invention, for pressure protection and air conditioning of high speed vehicles, fresh air is taken in and conducted into the vehicle interior via an air conditioning device in the form of an air conditioning apparatus, and the same amount of air is conducted from the vehicle interior as exhaust air. Herein, the control takes place via means for determining the pressure and means for determining the air quality. Via the air conditioning apparatus, only as much air is conditioned as is required, based on the occupancy in the vehicle interior.

A preferred variation of the assembly of the present invention for pressure protection and for air conditioning of high speed vehicles comprises multiple components of a fresh air side and an exhaust air side. The fresh air side includes the combination of a first blower and a first pressure protection valve. The exhaust air side includes the combination of an at least two-stage speed-adjustable, second blower and a second pressure protection valve. In addition, the assembly includes means for adjustment of the mixture ratio of fresh air/recirculating air and means for conditioning fresh air and recirculating air. For controlling the assembly, the latter contains a pressure sensor and/or the possibility of processing of a signal of the external train control and means for measuring the air quality in the vehicle interior.

In particular, by use of a CO₂ sensor, the CO₂ content is permanently monitored as a reference value of the concentration of noxious and offensive-smelling materials prevailing in the vehicle interior, which permits the required fresh air amount to be dispensed according to the occupancy and according to the frequency of the pressure events. The use of other sensors is contemplated, which do not measure the CO₂ concentration or which measure not only the CO₂ concentration, but the concentration of the actual, disturbing gases.

The advantage of this system and other systems of the present invention relative to systems known until now with high pressure blowers with very steep characteristic lines (for example, described in EP 0 751 054 A1) or the combination of this type of high pressure blowers and pressure protection valves (for example, described in DE 44 32 277 A1) or the combination of fast, speed adjustable blowers and specialized throttle flaps (for example, described in DE 196 49 664 C2), which all have the same goal of supplying an approximately constant fresh air amount independently of the occupancy, includes the combination of lowering energy consumption because of the elimination of the high pressure blower and the avoidance of noise emissions in generally connected to the use of this type of blower on the one hand, as well as the lowering of energy consumption due to the need conforming cooling and heating, on the other hand.

The advantage of this system and other systems of the present invention known until now with multiple fresh-air side pressure protection valves and multiple exhaust air side exhaust blowers (for example, described in DE 197 55 097 C1) comprises the minimization of the number of required components and a lowering of energy consumption because of the need conforming cooling and heating.

Further advantageous embodiments of the present invention are provided in the dependent claims or the following description of preferred embodiments, in which reference is made to the accompanying figures. In the drawings:

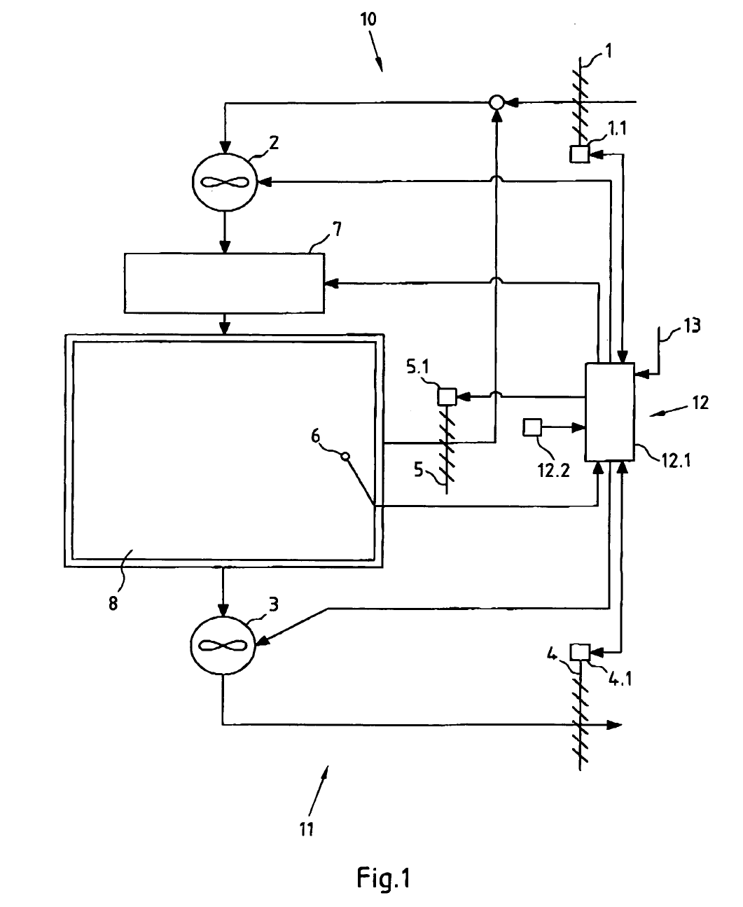

FIG. 1 shows a schematic representation of a preferred variation of the assembly of the present invention for performing a first preferred variation of the method of the present invention;

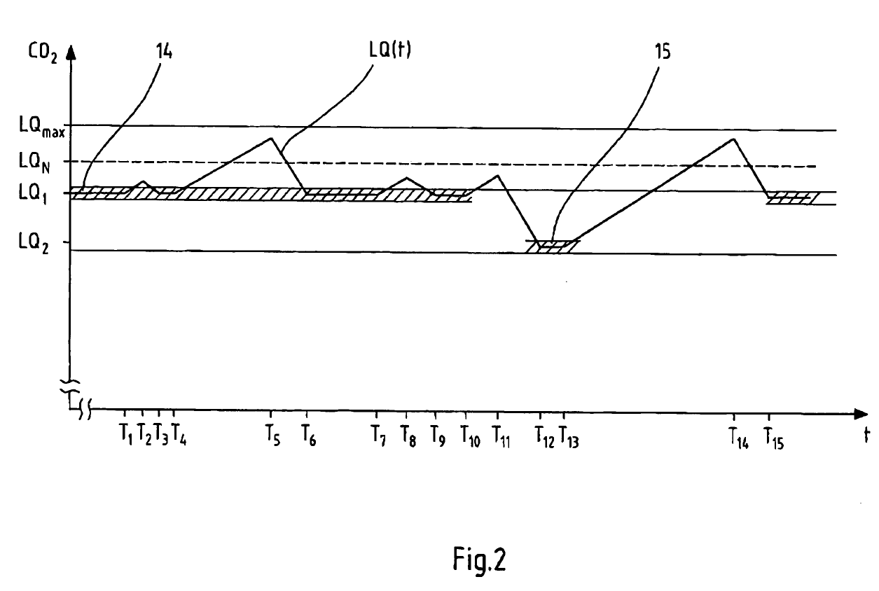

FIG. 2 shows the temporal development of an air quality value with performance of the method of FIG. 1; and

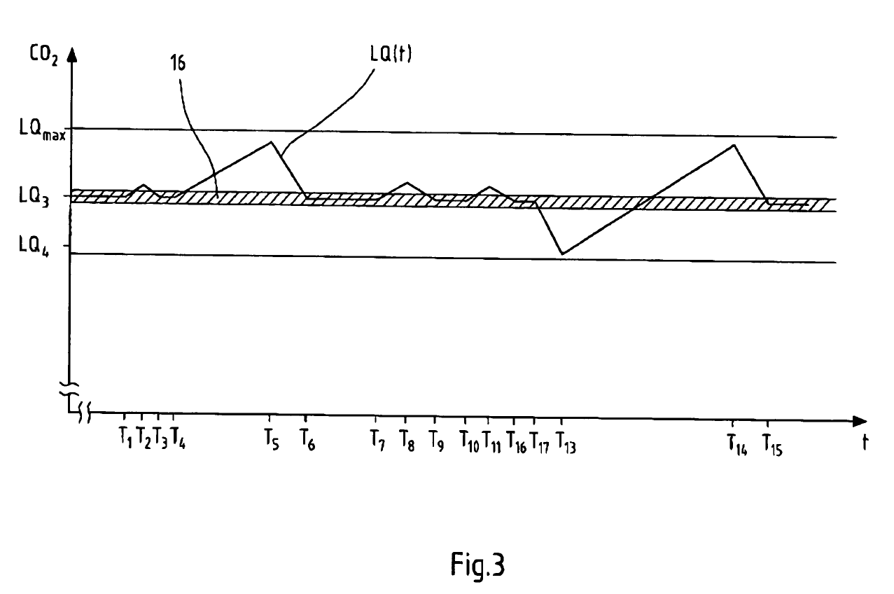

FIG. 3 shows the temporal development of an air quality value with performance of a second preferred variation of the method of the present invention.

The preferred embodiment of the inventive arrangement for pressure protection and for air conditioning of a high speed rail vehicle comprises multiple components of a fresh air side and an exhaust air side according to FIG. 1.

On the fresh air side, the assembly includes an air supply device 10 for conducting supply air into the vehicle interior 8. The air supply device 10 includes in combination a fresh air supply device in the form of a first blower 2 of constant speed and a first pressure protection valve 1, a recirculating air device in the form of a continuously adjustable recirculating air screen 5, via which recirculating air is returned by means of the first blower 2 from the vehicle interior 8 into the vehicle interior 8, and an air conditioning unit in the form of one or more heat exchangers 7.

On the exhaust air side, the assembly includes the combination of an exhaust air device 11 with an exhaust air-blower device, which includes an exhaust air blower in the form of an at least two-stage speed-adjustable second blower 3, and a second pressure protection valve 4.

On the blowers 2, 3, no particular specifications with reference to the steepness of their supply characteristic lines are placed; any desired blower, for example, an axial or radial type of construction, is contemplated.

The control of the assembly takes place via a control 12.1 of a control device 12, which is connected with the blowers 2, 3, the adjustment devices 1.1, 4.1, and 5.1 of the pressure protection valves 1, 4 and the recirculating air screen 5, as well as the heat exchanger 7.

For control of the assembly, in addition, a pressure sensor 12.2 and the possibility of processing of a signal of the external train control is provided, which is transmitted over the signal line 13 to the control device. It is understood, however, that, with other variations, the pressure sensor or the control via signals of the external train control may also be provided alone. Likewise, the pressure sensor also may be arranged at any other point, for example, in the adjustment device 1.1 of the pressure protection valve 1, the adjustment device 4.1 of the pressure protection valve 4, or in the vehicle interior.

In addition, for control of the assembly, means for determining an air quality value and connected with the control 12.1 are provided in the form of a CO₂ sensor 6 in the vehicle interior 8. Alternatively, of course, instead of the CO₂ sensor, another sensor may be used, which does not monitor or not only monitors the CO₂ concentration, but the concentration of other chemical or biological substances, for example, the actual interfering gases.

The fresh air and the recirculating air are conditioned via the heat exchanger 7 of the combined air conditioning and pressure protection assembly.

The individual manner of operation of the combined air conditioning and pressure protection assembly will be explained next with reference to FIG. 1 and FIG. 2, which shows schematically the temporal development LQ(t) of an air quality value, namely, the CO₂ concentration, with performance of the method of the present invention with the assembly of FIG. 1 for a determined travel route section:

With operation without pressure events, the first pressure protection valve 1 and the second pressure protection valve 4 are opened. The first blower 2 supplies fresh air from the surrounding environment and recirculating air from the vehicle interior. The second blower 3 supplies exhaust with low blower stage. The position of the recirculating air screen 5, thus, the mixing ratio of fresh air/recirculating air, is directed according to the CO₂ concentration prevailing in the vehicle interior or the actual prevailing concentration of the relevant harmful substance, which are permanently detected by the CO₂ sensor 6 or another sensor.

The control of the recirculating air screen 5 takes place therefore in dependence on the permanently detected CO₂ concentration prevailing in the vehicle interior and therewith, the actual occupancy in the vehicle interior 8, such that the CO₂ value lies in a first normal operation before the time point T₁ in a predetermined, narrow tolerance range 14 at a first, predetermined CO₂ value LQ₁. This tolerance range amounts to approximately 10% of the first provided CO₂ value LQ₁ and is arranged symmetrical to this, that is, the deviation from LQ₁ amounts to ±5% of LQ₁. Thus, it is ensured that via the heat exchanger 7 of the air conditioning assembly, only as much fresh air is conditioned as is necessary based on the occupancy in the vehicle interior 8.

At a time point T₁, a pressure event occurs. The operation during a pressure event is characterized in that with the occurrence of a pressure event, which is detected by the pressure sensor, the first pressure protection valve 1 and the second pressure protection valve 4 are closed and the recirculating air screen 5 is opened to a maximum. The first blower 2 nuns unchanged and supplies only 100% recirculating air from the vehicle interior 8. The second blower 3 is switched off by the control device and therefore does not run.

Directly after the pressure fluctuation, which ends at time point T₂, in a first scavenging operation, the first pressure protection valve 1 and the second pressure protection valve 4 are opened and the recirculating screen 5 is opened according to the CO₂ concentration in the vehicle interior 8 detected by the CO₂ sensor 6, so that a higher fresh air portion is supplied than in the first normal operation. The first blower 2 runs unchanged and supplies fresh air from the surrounding environment and recirculating air from the vehicle interior. The second blower 3 supplies a first air flow of exhaust air with low blower stage. At the time point T₃, again, it is switched into the first normal operation, in which then again, the fresh-air minimized control for keeping the tolerance range 14 takes place.

After an accumulation of pressure events or a long pressure event, which begins at T₄ and ends at T₅, the control device or the CO₂ sensor 6 or another sensor recognizes an exceeding of a normal value LQ_{N} of the CO₂ concentration or the actual prevailing concentration of the relevant harmful substance in the vehicle interior 8. In this case, at the time point T₅, in a second scavenging operation, the first pressure protection valve 1 and the second pressure protection valve 4 are opened and the recirculating screen 5 is completely closed. The first blower 2 runs unchanged and supplies only 100% fresh air. The efficient lowering of the CO₂ concentration or the actual prevailing concentration of the relevant harmful substance in the vehicle interior 8 is supported in that the second blower 3 supplies an air flow of exhaust air with high blower stage which is increased relative to the first air flow. This type of operation is maintained until time point T₆, at which the normal value LQ_{N} of the CO₂ concentration or the relevant harmful substance detected by the CO₂ sensor 6 or another sensor in the vehicle interior 8 is sufficiently far under-run or until a new pressure event occurs.

At time point T₆, then, again it is switched over into the first normal operation, in which then again, the fresh air minimized control takes place for retaining the tolerance region 14.

Between the time points T₇ and T₁₀, again, an operation takes place, such as that already described for the interval T₁ through T₄.

At time point T₁₀, a comparably short pressure event occurs anew, which ends at T₁₁. From the route course and the position and speed of the vehicle, however, it is known that at time point T₁₃, a very long pressure event will occur. The control device thus switches into the above-described second scavenging operation affected by corresponding signals of the external train control, and ending at time point T₁₂. Thus, through the duration of the second scavenging operation selected to correspond to the actual assessed occupancy of the vehicle, the CO₂ concentration is lowered to a value LQ₂ below LQ₁. This serves to ensure that the upper limit LQₘₐₓ of the CO₂ concentration in the subsequent long pressure fluctuation between T₁₃ and T₁₄ is not exceeded.

At time point T₁₂, then it is switched over into normal operation, in which, as described with reference to the first normal operation, the control of the fresh air-recirculating air ratio takes place, such that a second tolerance range 15 is maintained The extent of the tolerance range 15 thereby corresponds to the extent of the first tolerance range 14. The difference to the first normal operation is merely that the tolerance range 15 is held kept around a lowered value LQ₂. Then, in the second normal operation as well, the fresh-air minimizing control for keeping the tolerance region 15 takes place again.

At time point T₁₄, finally it is switched again into a second scavenging operation, in order to lower the CO₂ concentration quickly to the value LQ₁. Then, at time point T₁₅, it is switched into a first normal operation again.

It is to be understood that the control of the fresh air portion and the recirculating air portion, in particular, in the scavenging operation, can also take place with other variations of the method of the present invention, in such a manner that, in the control device, in a first step for assessment of the occupancy in the vehicle interior, a change value representative for the change of the air quality value during the pressure protection operation is determined. Thus, for example, the temporal change dLQ of the air quality value during the pressure protection operation between time points Tₙ and Tₙ₊₁ can be determined according to the following formula:

$$dLQ = \frac{Δ LQ}{Δ T} = \frac{LQ ( {T}_{n + 1} ) - LQ ( {T}_{n} )}{{T}_{n + 1} - {T}_{n}}$$

where LQ(Tₙ) is the air quality value at time point Tₙ and LQ(Tₙ₊₁) is the air quality at time point Tₙ₊₁. From this change value dLQ, then, with reference to the experience values, the actual occupancy in the vehicle interior can be assessed.

The air quality value at the end of the pressure protection operation at time point Tₙ₊₁, then, is compared in a first comparison at the end of the pressure protection operation with a predetermined first threshold value. In a second step, then, in dependence on the change value dLQ and the first comparison, the fresh air portion during the scavenging operation is determined in dependence on the actual occupancy in the vehicle interior.

In the second step, then, in dependence on the change value and the first comparison, the initiation time point of the scavenging operation and/or the duration of the scavenging operation and/or the intensity of the scavenging operation may be determined. Thus, preferably, also the position of the vehicle on the known travel route is taken into consideration, that is, long and/or intensely scavenged, if, for example, a long pressure event or a correspondingly short succession of several pressure events is imminent, in order to prevent an increase of the CO₂ concentration over an acceptable value.

As noted above, from the change value dLQ, and with reference to the experience values, the actual occupancy in the vehicle interior can be assessed. This assessment on the actual occupancy may be accomplished with other variations of the invention generally also for the control of the fresh air-recirculating air ratio in normal operation. In order to obtain this assessment, for a determined duration, a stable fresh air-recirculating air ratio can be vented and the change of the air quality value can be analyzed accordingly. In this context, if necessary, also temporarily, a pressure protection operation may be simulated, that is, it may be vented, without outer pressure event with a recirculating air portion of 100%.

FIG. 3 shows schematically the temporal development LQ(t) of an air quality value, namely, the CO₂ concentration for the determined travel route section from FIG. 2 upon performance of a further, preferred variation of the method of the present invention with the assembly of FIG. 1:

The development of the air quality value LQ(t) and the control of the components of the assembly correspond up to time point T₁₁, and between the time points T₁₃ and T₁₅, to the development or control, as was described with reference to FIG. 2, so that at this point, merely reference is made to the above explanations. Thus, here, only the differences with respect to the variation from FIG. 2 are shown.

One difference is that in normal operation without pressure fluctuation, always a fresh air minimized control by the control device takes place, which serves to maintain a tolerance region 16 at a predetermined air quality value LQ₃. The air quality value LQ₃ corresponds to the air quality value LQ₁ from FIG. 2 and the tolerance range 16 corresponds to the tolerance range 14 from FIG. 2.

At time point T₁₀, a comparably short pressure event occurs, which ends at T₁₁. From the route development and the position and the speed of the vehicle, however, it is known that at time point T₁₃, a very long pressure event will occur The control device first switches at T₁₆ into the above-described fresh air minimized normal operation, affected by corresponding signals of the external train control. At time point T₁₆, that is, before the pressure event at T₁₃, likewise from affects of corresponding signals of the external train control, a second scavenging operation is switched into, which lasts until time point T₁₃. In this manner, by the duration of the second scavenging operation selected according to the assessed actual occupancy of the vehicle, the CO₂ concentration is lowered to a value LQ₄ below LQ₃. This serves to ensure that the upper limit LQₘₐₓ of the CO₂ concentration in the subsequently long pressure event is not exceeded between T₁₃ and T₁₄.

At time point T₁₄, it is again switched over into a second scavenging operation, in order to quickly lower the CO₂ concentration to the value LQ₃. At time point T₁₅, then, normal operation is switched into again.

The invention was described above with reference to example, in which only in normal operation, a predetermined narrow tolerance region of the air quality value was maintained It is to be understood, however, that with other variations of the invention depending on the occupancy and the selection of the tolerance region, the corresponding tolerance range can be maintained also during the scavenging operation.

1. A method for air conditioning of high-speed vehicles, in particular, rail vehicles, in which for keeping of at least one predetermined limit of at least one air quality value in the vehicle interior (8), fresh air is taken in from the environment of the vehicle and supply air processed via at least one air conditioning device (7) is supplied to the vehicle interior (8), said supply air including a fresh air portion and/or recirculating air portion of the recirculating air recirculated from the vehicle interior (8), characterized in that the control takes place via means (6) for determining the air quality value, wherein the fresh air portion is kept to a minimum in dependence on the occupancy in the vehicle interior (8) in such a manner that a predetermined tolerance range of the air quality value is substantially kept at least in normal operation without pressure events.

2. The method according to claim 1, characterized in that the fresh air portion is kept at a minimum depending on the occupancy in the vehicle interior (8) in such a manner that a predetermined narrow tolerance range of the air quality value is substantially kept, wherein the tolerance range of the air quality value, in particular, amounts essentially to 20% at the highest, preferably, 10% at the highest, of a predetermined air quality value.

3. The method according to claim 1 or 2, characterized in that the tolerance range is kept around a variable air quality value, wherein, preferably, the variation of the air quality value takes place in dependence on the position of the vehicle on the known route course.

4. The method according to one of the preceding claims, characterized in that
in the event of pressure protection as a result of an outer pressure event, a pressure protection operation takes place, in which the fresh air portion essentially is equal to zero,
after the end of the pressure protection situation and before shifting to a normal operation, a scavenging operation takes place, in which the fresh air portion is kept the same or greater relative to the fresh air portion in normal operation.

5. The method according to claim 4, characterized in that for control of the fresh air portion and the recirculation portion in the scavenging operation in a first step:
for assessing the occupancy of the vehicle interior, a change value representative for the change of the air quality value during the pressure protection operation is determined, and
the air quality value is compared in a first comparison at the end of the pressure protection operation with a predetermined first threshold value, and
in a second step, depending on the change value and the first comparison, the fresh air portion during the scavenging operation is determined.

6. The method according to claim 5, characterized in that in the second step, depending on the change value and the first comparison, the initiation time point of the scavenging operation and/or the duration of the scavenging operation and/or the intensity of the scavenging operation is determined.

7. The method according to one of the preceding claims, characterized in that as the air quality value, a value representative for the CO₂ concentration in the vehicle interior (8) and/or a value representative for another chemical or biological measurement category is used.

8. The method according to one of the preceding claims, characterized in that
with a normal operation without pressure events and/or with a first scavenging operation after a short pressure events exhaust air is supplied into the surrounding environment of the vehicle via an exhaust air-blower device (3), wherein the exhaust air-blower device (3) supplies exhaust air from the vehicle interior (8) with a first air flow, and
the exhaust air-blower device (3), for an adaptation of the air quality value in the vehicle interior (8) to a predetermined air quality value, said adaptation being accelerated compared with the first scavenging operation, supplies exhaust air with a second air flow increased relative to the first air flow with a second scavenging operation after a sufficiently long pressure event, whereby this type of operation is maintained in particular until the air quality value reaches a predetermined value or a new pressure event occurs.

9. The method according to claim 8, characterized in that the exhaust air-blower device (3) is switched off with occurrence of a pressure event.

10. The method according to one of the preceding claims, characterized in that the switch-over between types of operation, in particular, the switch-over to a pressure protection operation and/or a scavenging operation, in which the fresh air portion is kept the same or greater relative to the fresh air portion in a normal operation without pressure event, is triggered by a signal of the external train control.

11. An assembly for air conditioning of high speed vehicles, in particular, rail vehicles, in particular, for performing the method according to one of the preceding claims, with an air supply device (10) for supplying supply air into the vehicle interior (8), which includes a fresh air supply device (1, 2) for supplying flesh air from the surrounding environment of the vehicle into the vehicle interior (8), a recirculating air return device (5) for returning recirculating air from the vehicle interior (8) into the vehicle interior (8), as well as at least one air conditioning device (7) for conditioning the supply air, and a control device (12) connected thereto for controlling the ration between the fresh air portion and the recirculating portion of the supply air, which is formed for keeping at least one predetermined limit of the air quality value in the vehicle interior (8), characterized in that the control device (12) includes means (6) for determining at least one air quality value in the vehicle interior (8) and is formed for minimizing the fresh air portion at least in a normal operation without pressure events as well as for essentially keeping a predetermined tolerance range of the air quality value in dependence on the occupancy in the vehicle interior (8).

12. The assembly according to claim 11, characterized in that the control device (12) is formed for minimizing the fresh air portion in dependence on the occupancy in the vehicle interior (8) and for essentially keeping a predetermined narrow tolerance range of the air quality value, wherein the tolerance range of the air quality value amounts in particular essentially to 20% at the most, preferably, 10% at the most, of a predetermined air quality value.

13. The assembly according to claim 11 or 12, characterized in that the control device (12), for assessing the occupancy in the vehicle interior (8), is formed for determining a change value representative for the change of the air quality value during pressure protection operation, as well as for comparison of the air quality value in a first comparison at the end of a pressure protection operation with a predetermined first threshold value and is formed for subsequent determination of the fresh air portion during a scavenging operation after the pressure protection operation in dependence on the change value and the first comparison.

14. The assembly according to claim 13, characterized in that the control device (12) is formed for determining the initiation time point of the scavenging operation and/or the duration of the scavenging operation and/or the intensity of the scavenging operation in dependence on the change value and the first comparison.

15. The assembly according to one of claims 11 through 14, characterized in that the means for determining the air quality value includes a sensor (6) for a measured value representative for the CO₂ concentration in the vehicle interior (8).

16. The assembly according to one of claims 11 through 15, characterized in that an exhaust air-blower device (3) controlled by the control device (12) is provided for conducting away exhaust air into the surrounding environment of the vehicle, which
with a normal operation without pressure events and/or with a first scavenging operation after a short pressure event supplies a first air flow from the vehicle interior (8) and
with a second scavenging operation, for an adaptation of the air quality value in the vehicle interior (8) to a predetermined air quality value, said adaptation being accelerated relative to the first scavenging operation, after a sufficiently long pressure event supplies an increased second air flow relative to the first air flow, wherein this manner of operation is maintained, in particular, until the air quality value reaches a predetermined value or a new pressure event occurs.

17. The assembly according to claim 16, characterized in that the exhaust air-blower device includes at least one exhaust air blower (3), which is formed at least to be two-stage speed adjustable.

18. The assembly according to claim 16 or 17, characterized in that the control device (12) is formed for switching off the exhaust air blower (3) with the occurrence of a pressure event.

19. The assembly according to one of claims 11 through 18, characterized in that the control device (12), for switching-over between types of operation, in particular, for switching-over to pressure protection operation and/or a scavenging operation, in which the fresh air portion is kept the same or greater relative to the fresh air portion in a normal operation without pressure event, is formed to be triggered by a signal of the external train control.

20. The assembly according to one of claims 11 through 19, characterized in that the air supply device (10) comprises means (5) for adjustment of the ratio between the fresh air portion and the recirculating air portion of the supply air, said means being controlled by the control device (12), and comprising, in particular, an adjustable, preferably continuously adjustable, recirculating air screen (5) in the area of the recirculating air return device.

21. The assembly according to one of claims 11 through 20, characterized in that the air supply device (10) includes a first supply air blower (2), which supplies fresh air and recirculating air.

22. The assembly according to one of claims 11 through 21, characterized in that the control device (12) for determination and consideration of pressure events comprises at least one pressure sensor for determining the pressure conditions in the vehicle interior (8), and which, preferably, is arranged in the vehicle interior (8).
